(19) United States
(12) Patent Application Publication
(10) Pub. No.: US 2016/0147634 A1
(43) Pub. Date: May 26, 2016

(54) METHOD AND APPARATUS FOR OBTAINING CONSTRAINTS ON EVENTS

(71) Applicant: INTERNATIONAL BUSINESS MACHINES CORPORATION, ARMONK, NY (US)

(72) Inventors: BING LI, BEIJING (CN); XIANG LI, BEIJING (CN); XIAO JIAN LIAN, BEIJING (CN); DAN LIU, BEIJING (CN); HAIFENG LIU, BEIJING (CN); JING MEI, BEIJING (CN); GUO TONG XIE, BEIJING (CN); YI QIN YU, BEIJING (CN); JING ZHANG, BEIJING (CN)

(21) Appl. No.: 14/946,815

(22) Filed: Nov. 20, 2015

(30) Foreign Application Priority Data
Nov. 21, 2014 (CN) 201410673846.1

(51) Int. Cl. G06F 11/36

(52) U.S. Cl. CPC G06F 11/3608; G06F 11/3692

(57) ABSTRACT

Method and apparatus for obtaining constraints on events. The method includes: obtaining a correspondence between a goal and multiple candidate constraints associated with the event from multiple event sequences including the event, wherein each event sequence among the multiple event sequences is a series of historical events that are executed for achieving the goal; identifying an impact on the goal of at least one part of candidate constraints among the multiple candidate constraints based on the correspondence; and in response to metric of the impact satisfying a predefined condition, determining the at least one part of candidate constraints as the constraint. An apparatus for determining a constraint on an event and a method and apparatus for generating a Case Management Model from multiple event sequences are also provided.

### CROSS REFERENCE TO RELATED APPLICATION

This application claims priority under 35 U.S.C. §119 from Chinese Patent Application No. 201410673846.1 filed Nov. 21, 2014, the entire contents of which are incorporated herein by reference.

### FIELD OF THE INVENTION

Various embodiments of the present invention relate to Case Management Models, and more specifically, to a method and apparatus for obtaining a constraint on an event.

### BACKGROUND OF THE INVENTION

With the development of computer hardware and software technologies, computer aided systems now can offer management and support in every aspect of people's lives. For example, more and more areas like production management and office automation have witnessed computer aided software. Each area can have their own constraints. Technical solutions have been developed for generating Case Management Models based on these constraints and adapting these models to flows for managing and controlling various transactions in production.

In these technical solutions, relationships among various events in operational flows can be described using Case Management Models. Events perhaps need to satisfy various constraints. For example, some events are required, some can be repeatable, and some further have temporal dependencies with others, etc. After successfully obtaining constraints, which events are required to satisfy, a Case Management Model can be generated based on these constraints, and subsequently it can be monitored based on this Case Management Model whether each event sequence in real operational flow satisfies requirements of the Case Management Model.

In the processing procedure related to the Case Management Model, to obtain constraints which an event needs to satisfy is a basis for subsequent processing. Although some technical solutions for obtaining constraints on events have been developed so far, most of these technical solutions involve manual operations, or only consider the impact of a single constraint instead of the overall impact of multiple constraints. Therefore, how to obtain constraints on an event more accurately and effectively is now a focus of attention.

### SUMMARY OF THE INVENTION

Therefore, it is desired to develop a technical solution capable of obtaining a constraint on an event, and it is desired the technical solution can obtain a constraint on an event from multiple historical event sequences without any manual intervention. Further, it is desirable to develop a technical solution capable of automatically generating a Case Management Model based on multiple historical events.

According to one aspect of the present invention, there is provided a computer-implemented method for obtaining a constraint on an event. The method includes: obtaining a correspondence between a goal and multiple candidate constraints associated with the event from multiple event sequences including the event, wherein each event sequence among the multiple event sequences is a series of historical events that are executed for achieving the goal; identifying an impact on the goal of at least one part of candidate constraints among the multiple candidate constraints based on the correspondence; and determining the at least one part of candidate constraints as the constraint in response to metric of the impact satisfying a predefined condition.

In one embodiment of the present invention, there is provided a computer-implemented method for generating a Case Management Model from multiple event sequences. The method includes: extracting multiple events from the multiple event sequences; obtaining a constraint on the each event with respect to each event among the multiple events; and generating the Case Management Model based on the each event and the constraint on the each event.

In one embodiment of the present invention, there is provided an apparatus for obtaining a constraint on an event. The apparatus includes: an obtaining module configured to obtain a correspondence between a goal and multiple candidate constraints associated with the event from multiple event sequences including the event, wherein each event sequence among the multiple event sequences is a series of historical events that are executed for achieving the goal; an identifying module configured to identify an impact on the goal of at least one part of candidate constraints among the multiple candidate constraints based on the correspondence; and a determining module configured to determine the at least one part of candidate constraints as the constraint in response to metric of the impact satisfying a predefined condition.

In one embodiment of the present invention, there is provided an apparatus for generating a Case Management Model from multiple event sequences. The apparatus includes: an extracting module configured to extract multiple events from the multiple event sequences; an obtaining module configured to obtain a constraint on the each event with respect to each event among the multiple events; and a generating module configured to generate the Case Management Model based on the each event and the constraint on the each event.

By means of the methods and apparatuses of the present invention, constraints on events can be obtained more accurately and effectively without changing the existing technical solution as far as possible. In addition, multiple events can be extracted from multiple historical event sequences, constraints on the extracted events obtained, and further a Case Management Model generated.

### BRIEF DESCRIPTION OF THE SEVERAL VIEWS OF THE DRAWINGS

Through the more detailed description of some embodiments of the present invention in the accompanying drawings, the above and other objects, features and advantages of the present invention will become more apparent, wherein the same reference generally refers to the same components in the embodiments of the present invention.

FIG. 1 schematically shows an exemplary computer system/server 12 which is applicable to implement the embodiments of the present invention.

FIG. 2 schematically shows a block diagram of various types of constraint relationships in a Case Management Model.

FIG. 3 schematically shows a block diagram of a technical solution for obtaining a constraint on an event according to one embodiment of the present invention.

FIG. 4 schematically shows a flowchart of a method for obtaining a constraint on an event according to one embodiment of the present invention.

FIG. 5 schematically shows a correspondence between a goal and multiple candidate constraints associated with an event according to one embodiment of the present invention.

FIG. 6A schematically shows metrics of the impact on the goal of at least one part of candidate constraints according to one embodiment of the present invention.

FIG. 6B schematically shows metrics of the impact on the goal of at least one part of candidate constraints according to one embodiment of the present invention.

FIG. 6C schematically shows metrics of the impact on the goal of at least one part of candidate constraints according to one embodiment of the present invention.

FIG. 7 schematically shows a block diagram of the process of building a Case Management Model based on obtained constraint relationships according to one embodiment of the present invention.

FIG. 8 schematically shows a block diagram of the process of generating a Case Management Model from multiple event sequences according to one embodiment of the present invention.

FIG. 9A schematically shows a block diagram of an apparatus for obtaining a constraint on an event according to one embodiment of the present invention.

FIG. 9B schematically shows a block diagram of an apparatus for generating a Case Management Model from multiple event sequences according to one embodiment of the present invention.

### DETAILED DESCRIPTION OF THE PREFERRED EMBODIMENTS

Some preferable embodiments will be described in more detail with reference to the accompanying drawings, in which the preferable embodiments of the present invention have been illustrated. However, the present invention can be implemented in various manners, and thus should not be construed to be limited to the embodiments disclosed herein. On the contrary, those embodiments are provided for the thorough and complete understanding of the present invention, and completely conveying the scope of the present invention to those skilled in the art.

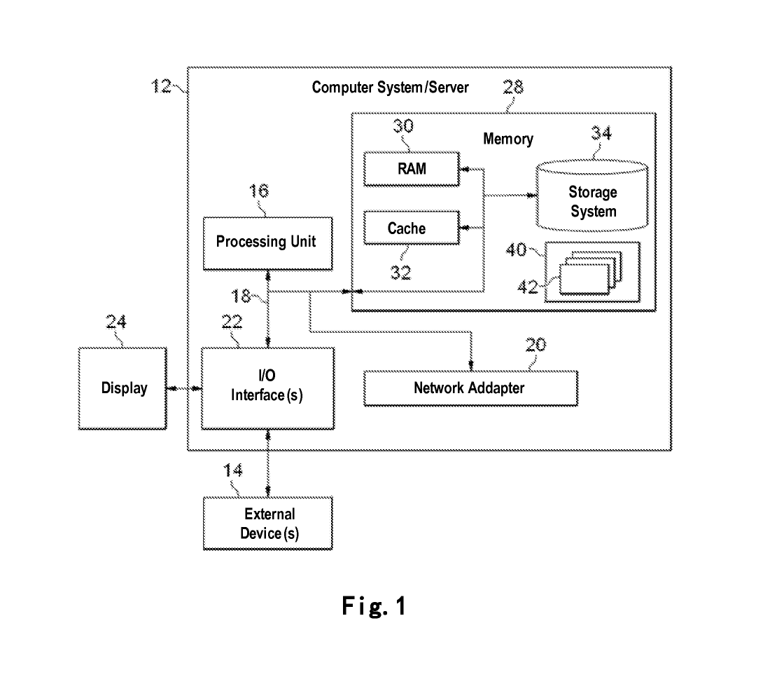

Referring now to FIG. 1, in which exemplary computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 can include, but are not limited to, one or more processors or processing units 16, system memory 28, and bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media can be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 can further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 can include at least one program product having a set (e.g., at least one) of program modules that are configured to carry out the functions of embodiments of the invention.

Program/utility 40, having a set (at least one) of program modules 42, can be stored in memory 28 by way of example, and not limitation, as well as an operating system, one or more application programs, other program modules, and program data. Each of the operating system, one or more application programs, other program modules, and program data or some combination thereof, can include an implementation of a networking environment. Program modules 42 generally carry out the functions and/or methodologies of embodiments of the invention as described herein.

Computer system/server 12 can also communicate with one or more external devices 14 such as a keyboard, a pointing device, display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

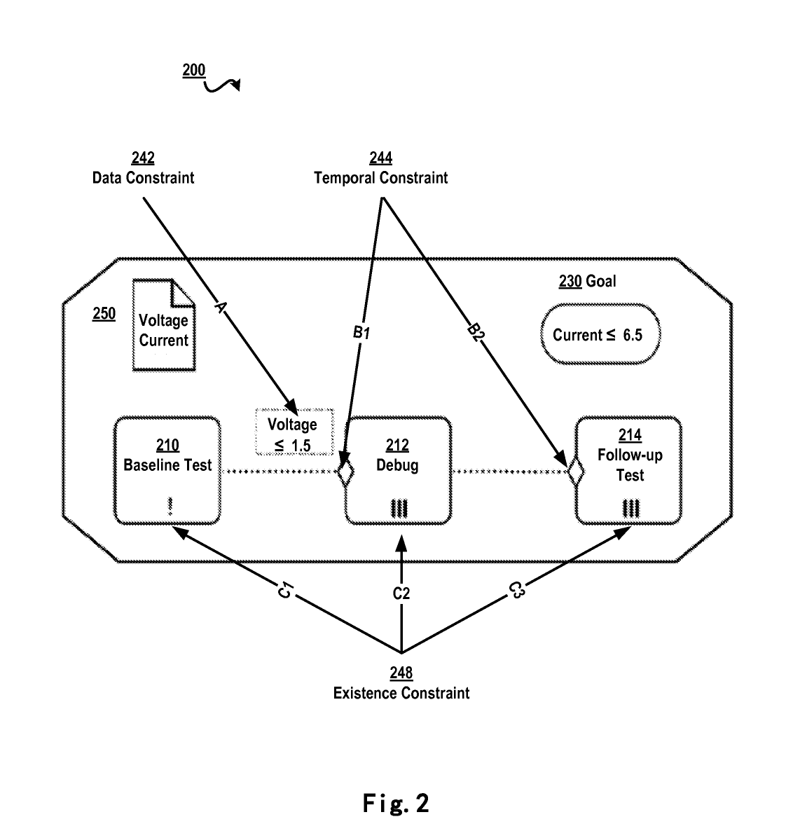

FIG. 2 schematically shows block diagram 200 of various types of constraint relationships in a Case Management Model. For the purpose of description, detailed description will be presented to particulars of various embodiments of the present invention by means of equipment maintenance throughout the context of the present invention. Generally, the Case Management Model shown in FIG. 2 means that it is desirable to achieve the goal of limiting an electric current to be less than or equal to 6.5 amperes by executing three events: baseline test 210, debug 212 and follow-up test 214.

With reference to FIG. 2, the Case Management Model can involve a variety of data such as events, parameters, goals, and constraints. Events refer to various tasks executed in the processing procedure, such as baseline test 210, debug 212 and follow-up test 214 (shown in blocks) executed on the equipment being maintained in the equipment maintenance example shown in FIG. 2. Parameters refer to various data items involved in the processing procedure, such as measured parameters in the equipment maintenance example shown in FIG. 2 (e.g., voltage parameter and current parameter denoted by reference numeral 250 in a dashed block). Goals refers to a goal desired to be achieved in the processing procedure. For example, “current ≦6.5 amperes” denoted by reference numeral 230 in an ellipse. Constraints refer to constraints which various events need to satisfy in the processing procedure.

There can be various types of constraints. For example, constraints can include a data constraint that refers to a condition to be satisfied by data in executing an event. As shown in FIG. 2, data constraint 242 shown in a dashed block indicated via an arrow A reads “voltage ≦1.5 volts”, which means “voltage ≦1.5 volts” should be satisfied in executing debug 212.

Constraints can include a temporal constraint that refers to a temporal condition for two events. As shown in FIG. 2, a dashed line ending with a diamond between baseline test 210 and debug 212 represents a temporal constraint. The constraint indicates that baseline test 210 should be executed first before debug 212. In addition, a dashed line ending with a diamond between debug 212 and follow-up test 214 also represents temporal constraint. The constraint indicates that debug 212 should be executed first before follow-up test 214. In FIG. 2, two constraints shown by arrows B1 and B2 belong to temporal constraints 244.

Constraints can include an existence constraint for describing whether an event is required or repeatable. In the context of the present invention, the existence constraint indicates requirements regarding whether an event occurs in an event sequence for achieving a goal and/or the number of occurrences. Specifically, a required constraint indicates the event should occur at least once, and a repeatable constraint indicates the event can be repeated.

As shown in FIG. 2, “!” represents a required constraint, and “|∥” represents a repeatable constraint. In FIG. 2, all three constraints shown via arrows C1, C2 and C3 belong to existence constraints 248. For more particularities about graphical identifications of the Case Management Model, those skilled in the art can refer to specifications of the Case Management Model, which are not detailed here.

Note although throughout the context of the present invention the embodiments of the present invention are illustrated by taking equipment maintenance as a concrete application environment, those skilled in the art should understand the present invention can further be applied to other application environments. The present invention can be applied to a hospital environment for patient treatment. For example, referring to FIG. 2, event 210 can be blood test, event 212 can be treatment, event 214 can be other follow-up tests, parameters are results of test items Scr and HbAlc, a data constraint is SCr≦1.5, and a goal is HbAlc≦6.5.

Those skilled in the art should understand FIG. 2 merely depicts an example where a couple of events are included. However, in the real application environment, more events might be included, and each event further needs to satisfy more complex constraints. Existing manual based approaches are no longer applicable in the face of complex application environments.

On the other hand, various constraints do not exert an impact on the goal separately, but two or more constraints can jointly exert a positive or negative impact on the goal. Therefore, technical solutions in the prior art which consider the impact of a single constraint on the goal separately cannot accurately find the impact of each constraint on the goal, let alone accurately discovering constraints on the event.

Note according to different application environments, different candidate constraints might affect the goal to different degrees. For example, suppose there are included a total of n candidate constraints, while perhaps only one part of constraints exert a significant impact on the goal. It is an object of the various embodiments of the present invention to conveniently and rapidly find candidate constraints that exert a significant impact on the goal.

In view of the foregoing drawbacks in the prior art, the present invention proposes a technical solution for obtaining constraints on an event. In one embodiment of the present invention, there is proposed a method for determining constraints on an event, including: obtaining a correspondence between a goal and multiple candidate constraints associated with the event from multiple event sequences including the event, each event sequence among the multiple event sequences being a series of historical events that are executed for achieving the goal; determining an impact on the goal of at least one part of candidate constraints among the multiple candidate constraints based on the correspondence; and in response to a metric of the impact satisfying a predefined condition, determining the at least one part of candidate constraints as the constraints.

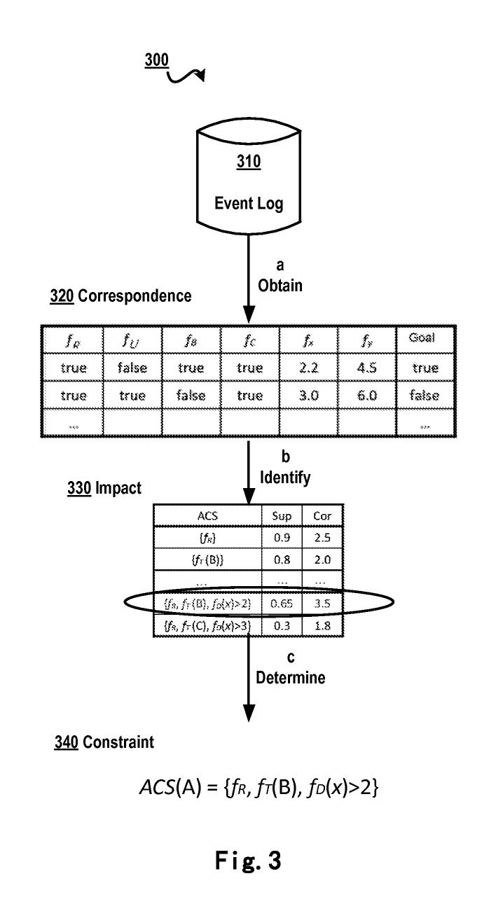

FIG. 3 depicts a schematic view 300 of a technical solution for obtaining a constraint on an event according to one embodiment of the present invention. In one embodiment of the present invention, candidate constraints can include various types of constraints described with reference to FIG. 2 above. Event log 310 includes multiple event sequences, each of which is a series of historical events that are executed for achieving the goal. In the application environment of equipment maintenance, each event sequence can be a sequence of historical events that are executed in maintaining an equipment. In the hospital environment of patient treatment, each event sequence can be a sequence of historical events that are executed in treating a patient.

In FIG. 3, as shown by arrow a, correspondence 320 between a goal and candidate constraints are obtained from multiple event sequences included in event log 310. Correspondence 320 records correspondences between the goal (the last column “Goal” in correspondence 320) and multiple candidate constraints (columns 1-6 in correspondence 320).

In this example, the multiple candidate constraints shown in columns 1-6 in correspondence 320 are symbolic representations of various constraints of baseline test 210 in FIG. 2. For example, symbols f_{R} and f_{U} shown in the 1^{st} and 2^{nd} columns represent existence constraints of baseline test 210, wherein f_{R} represents baseline test 210 is required and f_{U} represents baseline test 210 is unrepeatable. F_{B} and f_{C} represent temporal constraints of baseline test 210, and fₓ and F_{y} represent data constraints of baseline test 210.

Then, as shown by arrow b, impacts 330 on the goal of at least one part of candidate constraints (candidate constraints within a subset of the multiple candidate constraints) among the multiple candidate constraints are identified based on the correspondence. The size of the impacts can be measured using various metrics, which will be described in detail below. Finally, an impact satisfying a predefined condition such as a maximum value can be selected from impacts 330, and at least one part of candidate constraints corresponding to the impact are determined as the constraints as shown by arrow c. At this point, the determined constraint is a constraint such as constraint 340 exerting a significant impact on the goal, while candidate constraints exerting a minor impact on the goal can be ignored.

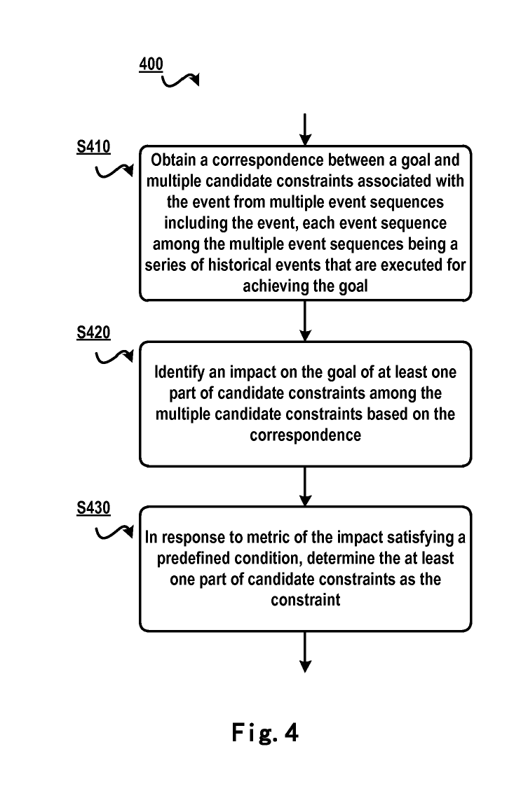

FIG. 4 schematically shows a flowchart 400 of a method for obtaining a constraint on an event according to one embodiment of the present invention. In step S410, a correspondence between a goal and multiple candidate constraints associated with the event is obtained from multiple event sequences including the event, each event sequence among the multiple event sequences being a series of historical events that are executed for achieving the goal.

In one embodiment of the present invention, those skilled in the art can customize the scope of the multiple candidate constraints. If it is desirable to consider all factors that might exert impacts on the goal, then contents in multiple respects can be considered such as existence constraints, temporal constraints and data constraints. On the other hand, only one part of constraints can be considered such as temporal constraints and data constraints. Alternatively, where it is found based on other technical solution that only one part of candidate constraints exert a great impact on the goal, only this part of candidate constraints can be considered.

In step S420, an impact on the goal of at least one part of candidate constraints among the multiple candidate constraints is determined based on the correspondence. In this embodiment, whether the satisfaction of the at least one part of candidate constraints trends to be consistent with the achievement of the goal can be used as the metric of the impact. Those skilled in the art can customize concrete computation equations based on the principle of confidence in statistics.

The computation equation of confidence is Confidence(U−>V)=P(U|v). Confidence means when an event U occurs, whether an event V will occur or its probability of occurrence. For example, if Confidence(U−>V)=1, this means both events U and V will occur definitely. If a value of Confidence(U−>V) is quite small, this means the occurrence of the event U has little to do with the fact whether the event V occurs. In one embodiment of the present invention, U can represent the satisfaction of the at least one part of candidate constraints, and V can represent the achievement of the goal. In this manner, the impact on the goal of the at least one part of candidate constraints can be obtained.

Those skilled in the art should understand in this embodiment, “at least one part of candidate constraints” among the multiple candidate constraints can be one or more candidate constraints. Since the multiple candidate constraints might affect one another, the number of to-be-evaluated candidate constraints that affect the goal can be increased in ascending order.

In step S430, in response to the metric of the impact satisfying a predefined condition, the at least one part of candidate constraints is determined identified as the constraint. For example, in this step, at least one part of candidate constraints that exert the maximum impact on the goal can be selected.

Particularities of each step of the present invention will be described by means of a concrete example. This example includes: three events such as an event A, an event B and an event C, two parameters such as a parameter c with a value range within positive numbers) and a parameter y with a value range of Booleans (T/F), and a goal y=T. An event log is as shown in Table 1 below:

TABLE 1
Event Log

| No. | Event Sequence |
|---|---|
| 1 | <(B, 4, F), (A, 3, T), (C, 3, T)> |
| 2 | <(C, 0, F), (A, 1, F), (A, 1, F)> |
| . . . | . . . |

In the event log shown in Table 1, each event sequence consists of 3 events. Specifically, an event sequence 1 includes three events: (B, 4, F), (A, 3, T) and (C, 3, T). Each event is represented as a three-tuple, wherein three elements represent the event's name, a value of x after the execution of the event is completed, and a value of y after the execution of the event is completed. For example, (B,4,F) represents after the execution of the event B is completed, x=4 and y=F and (A,3,T) represents after the execution of the event A is completed, x=3 and y=T.

Note values of parameters in each three-tuple are values of the parameters after the execution of an event in the three-tuple is completed. If it is desirable to obtain values, when an event in a three-tuple is executed, of parameters, reference can be made to values of parameters in a previous three-tuple in an event sequence. Specifically, regarding event sequence 1, if it is desirable to know values of x and y when the event A is executed, then as is clear from the three-tuple (B,4,F), x=4 and y=F when the event A is executed.

In one embodiment of the present invention, the obtaining a correspondence between a goal and multiple candidate constraints associated with the event from multiple event sequences including the event includes: based on each occurrence of the event in each event sequence among the multiple event sequences, constructing a constraint feature vector associated with the each occurrence, each element in the constraint feature vector representing a status of one candidate constraint among the multiple candidate constraints; and obtaining the correspondence based on the constraint feature vector and the goal.

Now the meaning of each occurrence of an event is explained with reference to a concrete example. Event sequence 1 records <(B, 4, F), (A, 3, T), (C, 3, T)>, and then it can be found the event A occurs only once in event sequence 1. Thus, one constraint feature vector can be generated based on one occurrence of the event A in event sequence 1. For another example, an event sequence 2 is <(C, 0, F), (A, 1, F), (A, 1, F)>, and then it can be found the event A occurs twice in event sequence 2. Thus, two constraint feature vectors can be generated based on two occurrences of the event A in event sequence 2. When the event log includes more event sequences, more constraint feature vectors can be generated based on each occurrence of the event A in other event sequences.

Each element in the constraint feature vector represents status of one candidate constraint among the multiple candidate constraints. Table 2 shows below the meaning of multiple candidate constraints for the event A.

TABLE 2
Candidate Constraints for Event A

| No. | Symbol | Meaning |
|---|---|---|
| 1 | f_{R} | existence constraint: event A is required |
| 2 | f_{U} | existence constraint: event A is unrepeatable |
| 3 | f_{T}(B) | temporal constraint: event B must be executed first |
| | | before event A |
| 4 | f_{T}(C) | temporal constraint: event C must be executed first |
| | | before event A |
| 5 | f_{D}(x) | data constraint: constraint of value of x on execution |
| | | of event A |
| 6 | f_{D}(y) | data constraint: constraint of value of y on execution |
| | | of event A |

When all the 6 candidate constraints are taken into consideration, status of the candidate constraints can be represented as a vector: (f_{R}, f_{U}, f_{T} (B), f_{T}(C), f_{D}(x), f_{D}(y)).

In one embodiment of the present invention, the constructing a constraint feature vector associated with the each occurrence includes: with respect to each element in the constraint feature vector, determining status of each candidate constraint among the multiple candidate constraints in an event sequence associated with the each occurrence; and building the constraint feature vector based on the status of the each candidate constraint.

Description is presented below to how to generate the constraint feature vector by means of a concrete example. For the occurrence (A,3,T) of the event A in event sequence 1, status of various candidate constraints can be analyzed one by one:

f_{R}: the event A is required, so f_{R}=T.

f_{U}: the event A is not repeatable, so f_{U}=T.

f_{T}(B): the event B is executed before the event A, so f_{T}(B)=T.

f_{T} (C): the event C is not executed before the event A, so f_{T}(C)=F.

f_{D} (x): by referring to the previous three-tuple (B,4,F), x=4 when the event A is executed.

f_{D} (y): by referring to the previous three-tuple (B,4,F), y=F when the event is executed.

As seen from the foregoing analysis, the constraint feature vector for the occurrence (A,3,T) of the event A in event sequence 1 is (T, T, T, F, 4, F). Next, by analyzing the first occurrence (A,1,F) of the event A in event sequence 2 by means of the above method, it can be learned that the constraint feature vector for the occurrence (A,1,F) of the event A in event sequence 2 is (T, F, F, T, 0, F). Based on the above principle, those skilled in the art can obtain constraint feature vectors for other occurrences of the event A.

In one embodiment of the present invention, types of the multiple candidate constraints include at least one of: existence constraint, temporal constraint and data constraint. The status of a candidate constraint can be obtained based on each occurrence of the event according to the type of the candidate constraint.

Specifically, for a repeatable existence constraint, whether an event is repeatable can be checked in an event sequence associated with an occurrence of the event; for a data constraint, values of various parameters when the event is executed can be checked; for a temporal constraint, it can be checked in an event sequence associated with an occurrence of an event whether the occurrence of the event and an occurrence of another event satisfy a temporal relationship.

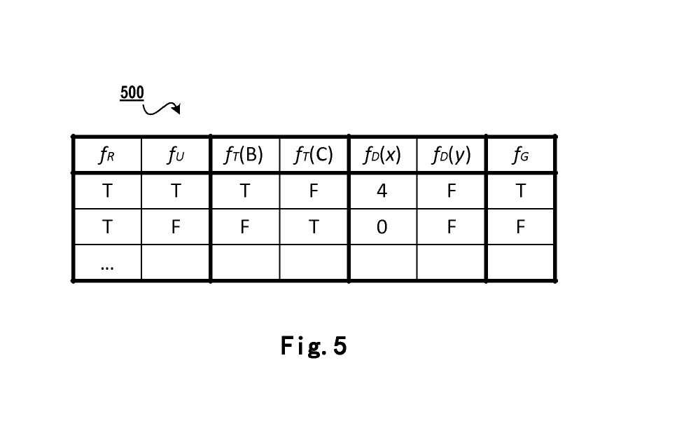

FIG. 5 schematically shows correspondences 500 between a goal and multiple candidate constraints associated with an event according to one embodiment of the present invention. Based on constraint feature vectors and whether the goal is satisfied, those skilled in the art can obtain correspondences as shown in FIG. 5. Specifically, when the execution of event sequence 1 is completed, y=T, so the goal is satisfied. At this point, in the table shown in FIG. 5 a value of a goal f_{G} corresponding to event sequence 1 is T. For another example, when the execution of event sequence 2 is completed, y=F, so the goal is satisfied. At this point, in the table shown in FIG. 5 a value of a goal f_{G} corresponding to event sequence 2 is F.

In one embodiment of the present invention, the determining an impact on the goal of at least one part of candidate constraints among the multiple candidate constraints based on the correspondence includes: generating at least one subset of the multiple candidate constraints; and with respect to each subset of the at least one subset, determining the impact on the goal of a candidate constraint in the each subset based on the correspondence.

In this embodiment, at least one part of candidate constraints can be selected from the multiple candidate constraints in increasing order, and further the impact on the goal of the selected at least one part of candidate constraints can be calculated. Specifically, a subset of the multiple candidate constraints can be selected, and the impact on the goal of the selected subset can be calculated. The number of candidate constraints in the subset can be increased in increasing order. For example, first a subset including only one candidate constraint (i.e., 1-tem subset) can be selected, and then a subset including two candidate constraints (2-item subset) can be selected, . . . , until the number of candidate constraints in a subset equals the number of the multiple candidate constraints.

In one embodiment of the present invention, the generating at least one subset of the multiple candidate constraints includes: generating 1-item subsets of the multiple candidate constraints, wherein each element in the 1-item subsets includes one candidate constraint among the multiple candidate constraints. In this embodiment, the initial 1-tem subsets can include 6 subsets, i.e., {f_{R}}, {f_{U}}, {f_{T}(B)}, {f_{T}(C)}, {f_{D}(x)}, and {f_{D}(y)}. Those skilled in the art can further define 1-item subsets including other elements according to needs of a concrete application environment, for example, can further perform NOT operations to some constraints, etc. In this manner, for each selected 1-item subset, the impact on the goal of the candidate constraint in the 1-item subset can be calculated based on the correspondences shown in FIG. 5.

In one embodiment of the present invention, there is further included: in at least one round, generating an n-item subset of the multiple candidate constraints based on an (n−1)-item subset of the multiple candidate constraints, wherein 2≦n≦the number of the multiple candidate constraints, and each element in the n-item subset includes n candidate constraints. After the 1-item subset is generated, the number of candidate constraints in the subset can be increased gradually to generate a 2-item subset, 3-item subset, etc.

In one embodiment of the present invention, typically the goal is affected not by all candidate constraints but by only one part of candidate constraints. Therefore, there is no need to generate a subset including the maximum number of candidate constraints, but a stop condition can be set. For example, whether to generate the n-item subset can be judged based on the impact on the goal of candidate constraints in the (n−1)-item subset. Specifically, the n-item subset can be generated based on the (n−1)-item subset whose impact on the goal exceeds a predefined threshold. Specifically, suppose a 1-item subset of the multiple candidate constraints has been generated, and the impact on the goal of {f_{T}(C)} is lower than the predefined threshold, then during the process of generating a 2-item subset in the next round, the candidate constraint {f_{T}(C)} can be no longer considered. Thereby, a subset that exerts a significant impact on the goal can be generated more accurately.

In one embodiment of the present invention, the determining, with respect to each subset of the at least one subset, the impact on the goal of a candidate constraint in the each subset based on the correspondence includes: with respect to each subset of the at least one subset, determining correlation on the goal of the candidate constraint in the each subset as the impact based on the correspondence.

In this embodiment, correlation reflects the correlation between the satisfaction of a candidate constraint in a subset and the achievement of the goal, and those skilled in the art can design a concrete computation equation according to needs of a concrete application environment. For example, f represents the candidate constraint in the subset, and f_{G} represents the goal, so the correlation can be calculated based on an equation below:

$$Cor ( f ) = \frac{N ( f , {f}_{G} ) * N ( f , {f}_{G} )}{N ( f , {f}_{G} ) * N ( f , {f}_{G} )}$$

wherein N(f,f_{G}) represents: the number of cases wherein both of f,f_{G} are true (T). Or those skilled in the art can further adopt other computation equation, so long as this equation can measure the degree of consistency between a candidate constraint and a goal.

In this embodiment, a predefined threshold condition can be set, and when correlation is lower than the threshold condition, then a subset whose correlation is lower than the threshold condition is not considered. For example, the threshold of correlation can be defined as 0.5, and when generating a subset in the next round, only those subsets whose correlation is higher than 0.5 are taken into consideration.

In one embodiment of the present invention, to further provider higher accuracy, the impact can further include additional factors, for example, can further consider the concept of support. In one embodiment of the present invention, there is further included: with respect to each subset of the at least one subset, determining support of the candidate constraint in the each subset based on the correspondence; and adding the support to the impact.

The support here refers to a ratio of the number of triggers of an event when satisfying a given constraint to the total number of triggers of the event. The event is triggered for a total of 10 times, wherein a constraint is satisfied in 8 triggers, and then the support of the constraint is 8/10=0.8.

By means of the method described above, those skilled in the art can determine the impact on the goal of the at least one part of candidate constraints among the multiple candidate constraints based on the correspondences as shown in FIG. 5. For example, first the impact on the goal of a candidate constraint in the 1-item subset of the multiple candidate constraints can be determined, and then the impact on the goal of candidate constraints in the 2-item subset of the multiple candidate constraints determined, etc.

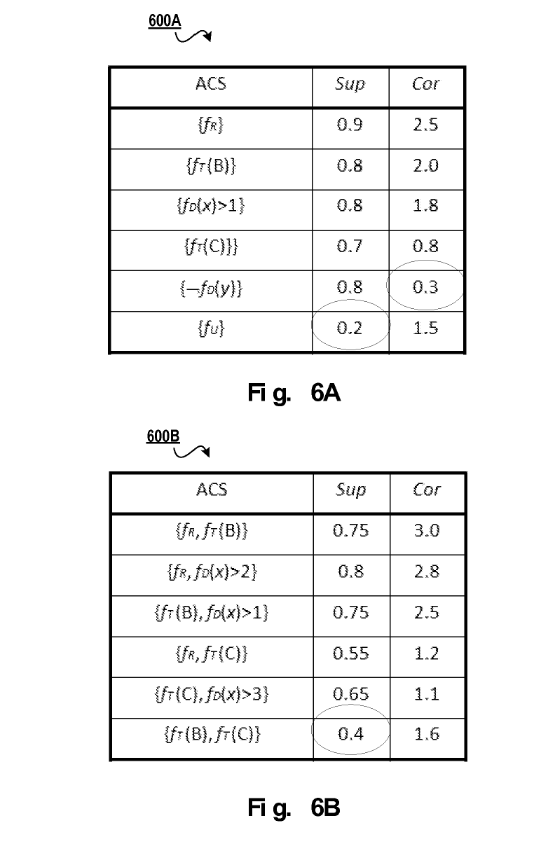

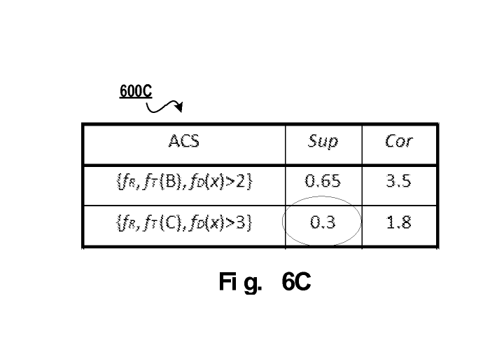

Specifically, FIGS. 6A-6C schematically shows metrics 600A-600C of the impact on the goal of at least one part of candidate constraints according to one embodiment of the present invention. Note although the metrics of the impact as depicted in FIGS. 6A-6C include support and correlation, in order to simplify calculation, the metrics of the impact can only include correlation. Where only correlation is included, a candidate constraint corresponding to the highest correlation can be selected as the found constraint with the highest impact. Or when the metrics of the impact include both support and correlation, predefined conditions can be set with respect to support and correlation, so as to find a candidate constraint with the highest impact on the goal.

As shown in FIG. 6A, there are shown metrics of the impact on the goal as exerted by candidate constraints in 1-item subsets of the multiple candidate constraints. Suppose threshold conditions are set with respect to support and correlation as below: support ≧0.5, correlation ≧0.5. When generating 2-item subsets, 1-item subsets (portions as shown in ellipse in FIG. 6A) that do not satisfy the two threshold conditions can be discarded. Therefore, when generating 2-item subsets, candidate constraints [symbol] f_{D}(u) and f_{U} cannot be considered, and 2-item subsets are generated based on the first 4 rows among impacts shown in FIG. 6A. Further, when generating 3-item subsets, { [symbol] f_{D}(y), f_{U}} cannot be considered.

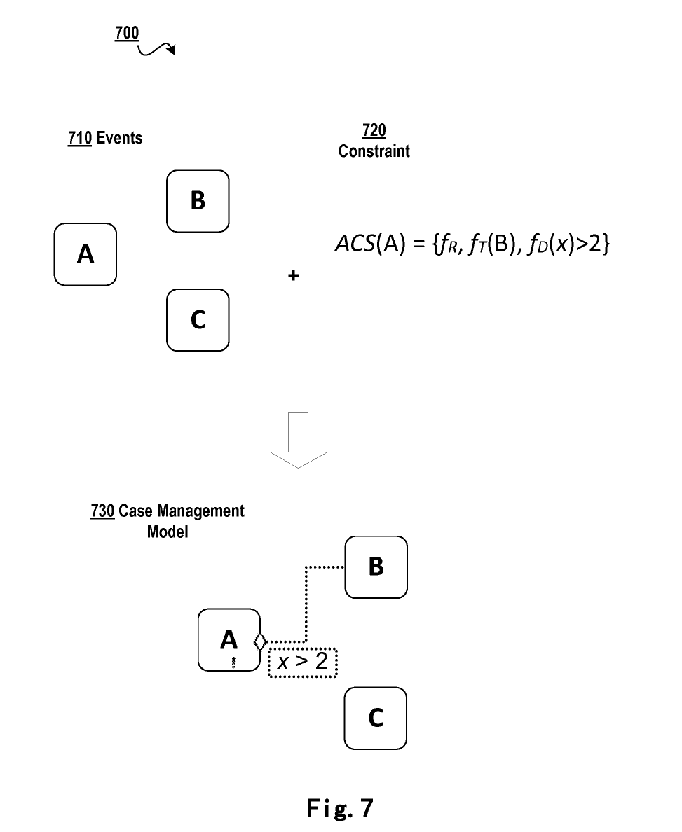

Those skilled in the art can obtain metrics of impacts as shown in FIGS. 6B and 6C by using the above equations for calculating support and correlation. Finally, a subset with the highest correlation is selected from impact metrics as shown in FIGS. 6A-6C. In this embodiment, candidate constraints in {f_{R}, f_{T}(B), f_{D}(x)>2} are candidate constraints that exert a significant impact on the goal.

Where candidate constraints (such as {f_{R}, f_{T}(B), f_{D}(x)>2}) with a significant impact on the goal have been found, a Case Management Model can be generated based on these candidate constraints. Specifically, FIG. 7 schematically shows a block diagram 700 of the process of building a Case Management Model based on obtain constraint relationships according to one embodiment of the present invention. The Case Management Model can include events A-C (as denoted by a reference numeral 710), and constraints 720 (including 3 constraints, i.e., f_{R}, f_{T}(B), f_{D}(x)>2) have been extracted based on the above method, so the three constraints can be added to the Case Management Model in order.

According to criteria of the Case Management Model, “!” represents the required existence constraint, so “!” is added under the event A; the dashed line ending with a diamond represents the temporal constraint, so a dashed line is added between the events A and B and a diamond symbol is added at the event A, which represents a temporal constraint f_{T}(B), i.e., first the event B is executed and then the event A is executed; the dashed block represents the data constraint, so a dashed block marked with X>2 is added at the event A, which represents a data constraint f_{D}(x)>2.

By means of the above technical solution, constraints on an event can be obtained from multiple historical event sequences and a Case Management Model is generated based on the obtained constraints, without any manual intervention.

In one embodiment of the present invention, there is provided a method for generating a Case Management Model from multiple event sequences, including: extracting multiple events from the multiple event sequences; with respect to each event among the multiple events, obtaining a constraint on the each event by using a method of the present invention; and generating the Case Management Model based on the each event and the constraint on the each event.

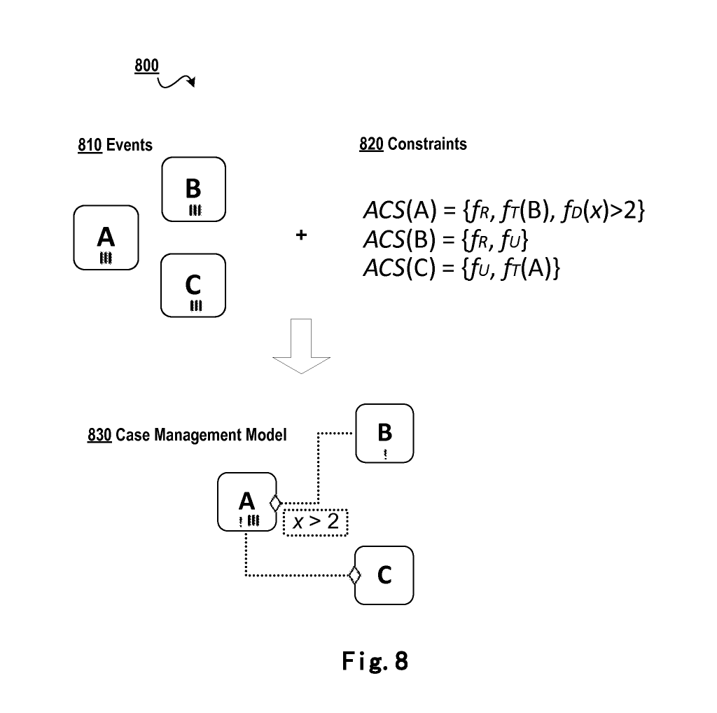

In this embodiment, the above method can be executed with respect to each event among multiple events, and a constraint on the each event can be obtained, and subsequently a Case Management Model describing an execution flow of the multiple events can be generated based on all the obtained constraints. FIG. 8 schematically shows a block diagram 800 of the process of generating a Case Management Model from multiple event sequences according to one embodiment of the present invention. As shown in FIG. 8, events 810 (including events A, B and C) are multiple events extracted from multiple event sequences, and constraints 820 include constraints on the events A, B and C. According to the method described with reference to FIG. 7, constraints on the events A, B and C are added to a Case Management Model one after another, whereby Case Management Model 830 is generated.

Various embodiments implementing the method of the present invention have been described above with reference to the accompanying drawings. Those skilled in the art can understand that the method can be implemented in software, hardware or a combination of software and hardware. Moreover, those skilled in the art can understand by implementing steps in the above method in software, hardware or a combination of software and hardware, there can be provided an apparatus based on the same invention concept. Even if the apparatus has the same hardware structure as a general-purpose processing device, the functionality of software contained therein makes the apparatus manifest distinguishing properties from the general-purpose processing device, thereby forming an apparatus of the various embodiments of the present invention. The apparatus described in the present invention includes several means or modules, the means or modules configured to execute corresponding steps. Upon reading this specification, those skilled in the art can understand how to write a program for implementing actions performed by these means or modules. Since the apparatus is based on the same invention concept as the method, the same or corresponding implementation details are also applicable to means or modules corresponding to the method. As detailed and complete description has been presented above, the apparatus is not detailed below.

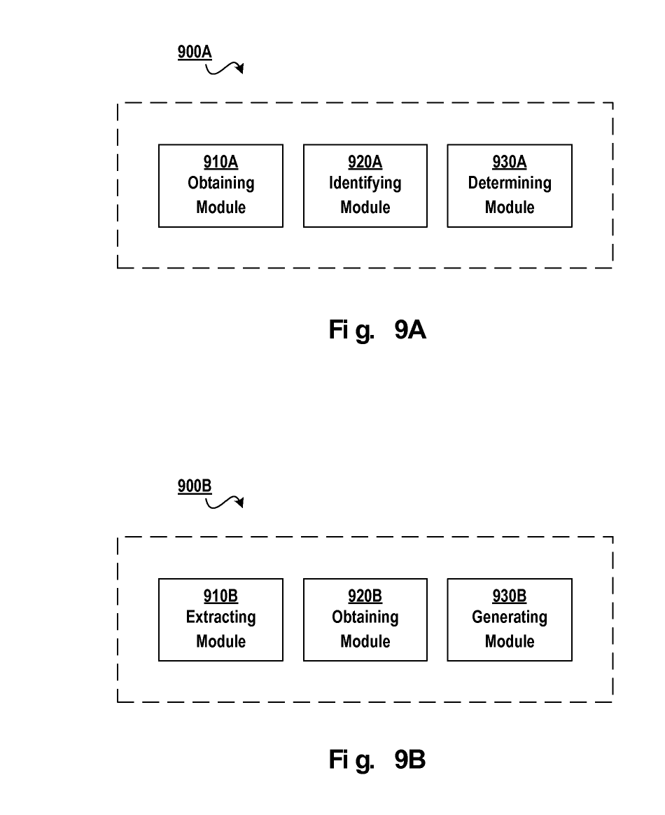

FIG. 9 depicts a block diagram 900 of an apparatus for obtaining a constraint on an event according to one embodiment of the present invention. Specifically, there is provided an apparatus for obtaining a constraint on an event, including: an obtaining module 910A configured to obtain a correspondence between a goal and multiple candidate constraints associated with the event from multiple event sequences including the event, each event sequence among the multiple event sequences being a series of historical events that are executed for achieving the goal; an identifying module 920A configured to identify an impact on the goal of at least one part of candidate constraints among the multiple candidate constraints based on the correspondence; and a determining module 930A configured to, in response to metric of the impact satisfying a predefined condition, determine the at least one part of candidate constraints as the constraint.

In one embodiment of the present invention, obtaining module 910A includes: a constructing module configured to, based on each occurrence of the event in each event sequence among the multiple event sequences, construct a constraint feature vector associated with the each occurrence, each element in the constraint feature vector representing status of one candidate constraint among the multiple candidate constraints; and an acquiring module configured to acquire the correspondence based on the constraint feature vector and the goal.

In one embodiment of the present invention, the constructing module includes: a status determining module configured to, with respect to each element in the constraint feature vector, determine status of each candidate constraint among the multiple candidate constraints in an event sequence associated with the each occurrence; and a building module configured to build the constraint feature vector based on the status of the each candidate constraint.

In one embodiment of the present invention, identifying module 920A includes: a generating module configured to generate at least one subset of the multiple candidate constraints; and an impact identifying module configured to, with respect to each subset of the at least one subset, identify the impact on the goal of a candidate constraint in the each subset based on the correspondence.

In one embodiment of the present invention, the generating module includes: a first subset generating module configured to generate a 1-item subset of the multiple candidate constraints, wherein each element in the 1-item subset includes one candidate constraint among the multiple candidate constraints.

In one embodiment of the present invention, there is further included: a second subset generating module configured to, in at least one round, generate an n-item subset of the multiple candidate constraints based on an (n−1)-item subset of the multiple candidate constraints, wherein 2≦n≦the number of the multiple candidate constraints, and each element in the n-item subset includes n candidate constraints.

In one embodiment of the present invention, the impact identifying module includes: a correlation calculating module configured to, with respect to each subset of the at least one subset, determine correlation on the goal of the candidate constraint in the each subset as the impact based on the correspondence.

In one embodiment of the present invention, there is further included: a support calculating module configured to, with respect to each subset of the at least one subset, determine support of the candidate constraint in the each subset based on the correspondence; and an adding module configured to add the support to the impact.

In one embodiment of the present invention, types of the multiple candidate constraints include at least one of: existence constraint, temporal constraint, and data constraint.

FIG. 9B depicts a block diagram 900B of an apparatus for generating a Case Management Model from multiple event sequences according to one embodiment of the present invention. In one embodiment of the present invention, there is provided an apparatus for generating a Case Management Model from multiple event sequences, including: an extracting module 910B configured to extract multiple events from the multiple event sequences; an obtaining module 920B including the apparatus of the present invention and configured to, with respect to each event among the multiple events, obtain a constraint on the each event by using; and a generating module 930B configured to generate the Case Management Model based on the each event and the constraint on the each event.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which includes one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for determining a constraint on an event, the method comprising:
obtaining a correspondence between a goal and multiple candidate constraints associated with the event from multiple event sequences including the event, wherein each event sequence among the multiple event sequences is a series of historical events that are executed for achieving the goal;
identifying an impact on the goal of at least one part of candidate constraints among the multiple candidate constraints based on the correspondence; and
determining the at least one part of candidate constraints as the constraint in response to a metric of the impact satisfying a predefined condition.

2. The computer-implemented method according to claim 1, wherein the step of obtaining a correspondence between a goal and multiple candidate constraints associated with the event from multiple event sequences including the event comprises:
constructing a constraint feature vector associated with each occurrence, wherein each element in the constraint feature vector represents the status of one candidate constraint among the multiple candidate constraints; and
acquiring the correspondence based on the constraint feature vector and the goal.

3. The computer-implemented method according to claim 2, wherein the step of constructing a constraint feature vector associated with the each occurrence comprises:
determining the status of each candidate constraint among the multiple candidate constraints in an event sequence associated with the each occurrence with respect to each element in the constraint feature vector; and
building the constraint feature vector based on the status of the each candidate constraint with respect to each element in the constraint feature vector.

4. The computer-implemented method according to claim 1, wherein the step of identifying an impact on the goal of at least one part of candidate constraints among the multiple candidate constraints based on the correspondence comprises:
generating at least one subset of the multiple candidate constraints; and
identifying the impact on the goal of a candidate constraint in the each subset based on the correspondence.

5. The computer-implemented method according to claim 4, wherein the step of generating at least one subset of the multiple candidate constraints comprises:
generating a 1-item subset of the multiple candidate constraints, wherein each element in the 1-item subset comprises one candidate constraint among the multiple candidate constraints.

6. The computer-implemented method according to claim 5, further comprising:
generating an n-item subset of the multiple candidate constraints based on an (n−1)-item subset of the multiple candidate constraints, wherein 2≦n≦the number of the multiple candidate constraints, and each element in the n-item subset comprises n candidate constraints.

7. The computer-implemented method according to claim 4, wherein the step of identifying the impact on the goal of a candidate constraint in the each subset based on the correspondence comprises:
determining correlation on the goal of the candidate constraint in the each subset as the impact based on the correspondence.

8. The computer-implemented method according to claim 7, further comprising:
determining support of the candidate constraint in the each subset based on the correspondence; and
adding the support to the impact.

9. The computer-implemented method according to claim 1, wherein types of the multiple candidate constraints comprise at least one of: existence constraint, temporal constraint, and data constraint.

10. A computer-implemented method for generating a Case Management Model from multiple event sequences, the method comprising:
extracting multiple events from the multiple event sequences;
obtaining a constraint on each event; and
generating the Case Management Model based on the each event and the constraint on the each event.

11. The computer-implemented method according to claim 10, wherein the step of obtaining a constraint on each event comprises:
obtaining a correspondence between a goal and multiple candidate constraints associated with the event from multiple event sequences including the event, wherein each event sequence among the multiple event sequences is a series of historical events that are executed for achieving the goal;
identifying an impact on the goal of at least one part of candidate constraints among the multiple candidate constraints based on the correspondence; and
determining the at least one part of candidate constraints as the constraint in response to a metric of the impact satisfying a predefined condition.

12. An apparatus for determining a constraint on an event, the apparatus comprising:
an obtaining module configured to obtain a correspondence between a goal and multiple candidate constraints associated with the event from multiple event sequences including the event, wherein each event sequence among the multiple event sequences is a series of historical events that are executed for achieving the goal;
an identifying module configured to identify an impact on the goal of at least one part of candidate constraints among the multiple candidate constraints based on the correspondence; and
a determining module configured to determine the at least one part of candidate constraints as the constraint in response to metric of the impact satisfying a predefined condition.

13. The apparatus according to claim 12, wherein the obtaining module comprises:
a constructing module configured to construct a constraint feature vector associated with the each occurrence, wherein each element in the constraint feature vector represents the status of one candidate constraint among the multiple candidate constraints; and
an acquiring module configured to acquire the correspondence based on the constraint feature vector and the goal.

14. The apparatus according to claim 13, wherein the constructing module further comprises:
a status determining module configured to determine status of each candidate constraint among the multiple candidate constraints in an event sequence associated with the each occurrence; and
a building module configured to build the constraint feature vector based on the status of the each candidate constraint.

15. The apparatus according to claim 12, wherein the identifying module comprises:
a generating module configured to generate at least one subset of the multiple candidate constraints; and
an impact identifying module configured to identify the impact on the goal of a candidate constraint in the each subset based on the correspondence.

16. The apparatus according to claim 15, wherein the generating module comprises:
a first subset generating module configured to generate a 1-item subset of the multiple candidate constraints, wherein each element in the 1-item subset comprises one candidate constraint among the multiple candidate constraints.

17. The apparatus according to claim 16, further comprising:
a second subset generating module configured to generate an n-item subset of the multiple candidate constraints based on an (n−1)-item subset of the multiple candidate constraints, wherein 2≦n≦the number of the multiple candidate constraints, and each element in the n-item subset comprises n candidate constraints.

18. The apparatus according to claim 15, wherein the impact identifying module comprises:
a correlation calculating module configured to determine correlation on the goal of the candidate constraint in the each subset as the impact based on the correspondence.

19. The apparatus according to claim 18, further comprising:
a support calculating module configured to calculate support of the candidate constraint in the each subset based on the correspondence; and
an adding module configured to add the support to the impact.

20. The apparatus according claim 12, wherein types of the multiple candidate constraints comprise at least one of: existence constraint, temporal constraint, and data constraint.

21. An apparatus for generating a Case Management Model from multiple event sequences, the apparatus comprising:
an extracting module configured to extract multiple events from the multiple event sequences;
an obtaining module configured to obtain a constraint on the each event with respect to each event among the multiple events; and
a generating module configured to generate the Case Management Model based on the each event and the constraint on the each event.

22. The apparatus according to claim 21, wherein the obtaining module comprises:
an obtaining module configured to obtain a correspondence between a goal and multiple candidate constraints associated with the event from multiple event sequences including the event, wherein each event sequence among the multiple event sequences is a series of historical events that are executed for achieving the goal;
an identifying module configured to identify an impact on the goal of at least one part of candidate constraints among the multiple candidate constraints based on the correspondence; and
a determining module configured to determine the at least one part of candidate constraints as the constraint in response to metric of the impact satisfying a predefined condition.
